(19) United States
(12) Patent Application Publication
(10) Pub. No.: US 2006/0203840 A1
(43) Pub. Date: Sep. 14, 2006

(54) Method and System for Filling 'Advertised' Vacancies

(75) Inventor: Kevin Michael Scott, Port Macquarie, NSW (AU)

Correspondence Address: Mr Kevin Scott, P O Box 1102, Port Macquarie, NSW, 2444, AU

(73) Assignee: Kevin Michael Scott, Port Macquarie, NSW (AU)

(21) Appl. No.: 11/164,715

(22) Filed: Dec. 2, 2005

(30) Foreign Application Priority Data
Dec. 2, 2004 (AU) 2004906891

(51) Int. Cl. H04L 12/42

(52) U.S. Cl. 370/455

(57) ABSTRACT

This invention concerns filling vacancies. It may, for example, be applied to finding replacements during staff shortages. Firstly, vacancy data and candidate data is stored (5). Requests from a candidate are received to view the vacancy data using a website. The processor (1) automatically sends vacancy information to the candidate to be viewed on the website. The processor (1) receives a request from the candidate to fill the vacancy and the request to fill the vacancy is accepted. Using the invention, candidates can view vacancies and automatically accept them. This makes filling of vacancies when there are time pressures convenient.

### TECHNICAL FIELD

This invention concerns filling vacancies. It may, for example, be applied to finding replacements during staff shortages, or to filling entire rosters. It may also be used to fill casually occurring service needs, such as the need for a child minding placement. It may be layered to integrate the filling of a vacancy with the provision of a service for a related period of time. For instance, integrating the filling of a nursing or nursing staff vacancy with the provision of child minding services for the same day.

### BACKGROUND ART

Currently in medical, education, commercial, hospitality, retail industries and other industries one of the most onerous and time-consuming tasks is finding enough employees to fill rosters and in particular finding replacement staff at short notice.

### SUMMARY OF INVENTION

The invention is a method for filling vacancy periods having a defined start and end comprising the steps of:

receiving vacancy data and storing it in a vacancy data store;

receiving candidate data and storing it in a candidate data store;

receiving a request from a candidate to view the vacancy data using a website;

automatically sending vacancy information to the candidate to be viewed on the website;

receiving a request from the candidate to fill the vacancy; and

accepting the request to fill the vacancy.

Using the invention, candidates can view vacancies and automatically accept them. This makes filling of vacancies when there are time pressures convenient and more efficient. In order to use the invention to fill vacancies the candidate must have their data, such as personal details, stored on the data store.

The vacancy data may include criteria that the candidate must meet in order to fill the vacancy and the candidate data may include information on criteria that is needed to fill the vacancy, wherein the step of sending vacancy data to the candidate comprises cross-matching the vacancy criteria with the criteria information of the candidate and only sending the vacancy data if the candidate meets the criteria.

The candidate data may comprise availability information of the candidate, wherein the step of sending vacancy data to the candidate comprises cross-matching the vacancy period with the availability information of the candidate and only sending the vacancy data if the candidate is available to fill the vacancy.

The step of accepting the request to fill the vacancy may be automatic. Alternatively, the method may further comprise the candidate contacting the employer or the employer contacting the candidate to first discuss the vacancy.

Candidates may be ranked according to a predetermined criteria. The step of sending vacancy data to the candidate may only be performed provided the candidate is of at least a predetermined ranking. The predetermined ranking may change as the amount of time until the defined start of the vacancy reduces. The predetermined criteria and predetermined ranking may be predetermined by the employer.

The vacancy data may include a monetary amount offered to the candidate who fills the vacancy. The monetary amount offered may increase as the amount of time until the defined start of the vacancy reduces.

The request from the candidate may include an alternate monetary amount that the candidate would be prepared to fill the vacancy for. The monetary amount may depend on the skills of the candidate.

The candidate may be an agency.

The vacancy data may include information on whether child care is also available for the vacancy period.

The receiving and sending steps may be performed using the Internet as the communication medium.

The request from the candidate to view the vacancy data may comprise the candidate logging into the website.

In another aspect of the invention is a computer system for filling vacancy periods having a defined start and end, comprising:

A candidate data store to accept and store candidate data;

A vacancy data store to accept and store vacancy data;

A processor connected to the Internet and operates to receive a request from a candidate to view the vacancy data using a website, to automatically send vacancy data to the candidate to be viewed on the website and to receive a request from the candidate to fill the vacancy, wherein the request to fill the vacancy is accepted.

In yet another aspect the invention provides a method for filling vacancy periods having a defined start and end comprising the steps of:

entering candidate data into a candidate data store;

entering vacancy data into a vacancy data store;

creating a list of candidates for a vacancy; and automatically ordering the list using a computer to rank the candidates according to predetermined criteria;

communicating the vacancy data to a first predetermined number of top ranked candidates; and

if a positive response to fill the vacancy is not received within a predetermined time, communicating the vacancy data to a second predetermined number of top ranked candidates that are next top ranked;

repeating the above step until the positive response to fill the vacancy has been received.

The step of communicating may comprise sending the invitation to a webpage.

### BRIEF DESCRIPTION OF THE DRAWINGS

An example of the invention will now be described with reference to the accompanying drawings; in which:

FIG. 1 is a schematic diagram of a computer system including individual health care facility and nurse systems; and

FIGS. 2A and 2B is a flow chart of the procedure when using Intranet, Internet, 3G, WAP, web based, wireless protocols, PDAs, telephone/voice/data/video messaging systems as automatic communication means.

### BEST MODES OF THE INVENTION

The example concerns the health care industry, and in particular the employing of casual nurses to replace absent employees on a day-to-day basis.

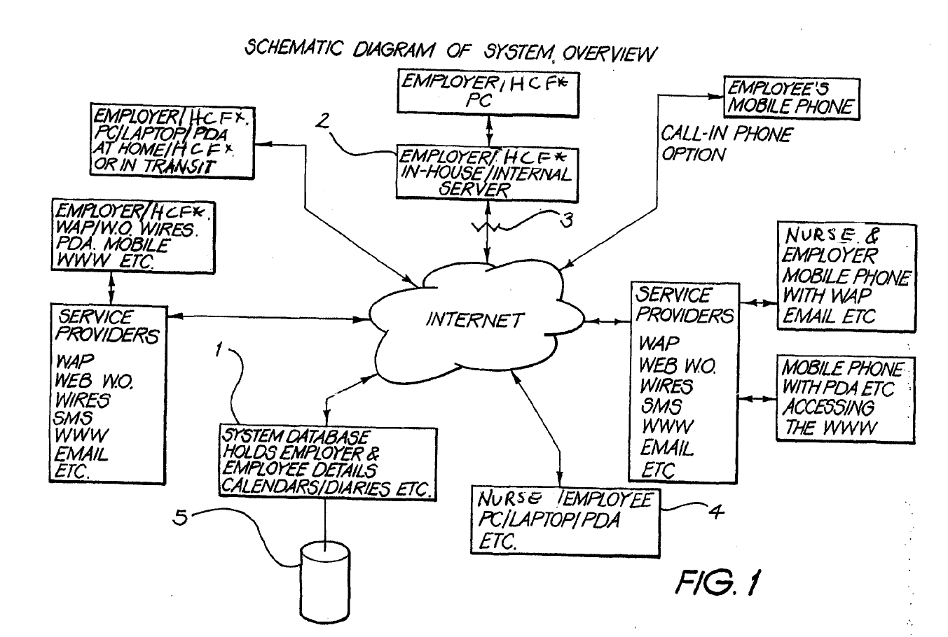

Referring first to FIG. 1, each health care facility registered with the system 1 is provided with a program for use on their internal sub-system 2 only, including a calendar/diary, on which they will store their own confidential information about prospective casuals, part-time employers or contract workers. Health care providers, regional health care organisations, ward types, nursing qualification categories and nurse classifications have specific nominated codes which are used throughout the entire system, by both health care facilities and nurses.

The health care facility's sub-system 2 will include information including its health care facility's identification number to uniquely identify each health care facility. The health care facility may also maintain details of the nursing commitments of each member of staff on their sub-system. The health care facility's calendar/diary includes dates of in-service, holidays and other relevant information such as long-service and maternity-leave dates where a replacement will be needed. Each system 2 is protected by a security screen 3 and a password.

Video streaming and/or presenting positive news and images about health care facility's locations/districts that are difficult to staff, in order to overcome stereotypes and to present a positive image. These powerful tools have the capacity to greatly assist in the recruitment and retention of casual nurses.

The health care facility may also include on their sub-system a predefined set of rules that will enable the health care facility to grade all prospective nurses/employees according to various criteria selected by them. For example the health care facilities will rank the nurses, for internal purposes of that health care facility only, into categories. An example of eight possible categories are:

1. Highly recommended

2. Recommended

3. Not Yet Ranked

4. Not previously employed at this health care provider

5. If required

6. Not recommended

7. Nurse has been requested not to be employed at this health care provider

8. Not to be employed

Factors that can be taken into account when grading nurses include, but is not limited to the following ranking filters:

1. Casual has basic qualifications e.g. registered nurse (A) or registered nurse (B);

2. Postcodes/Proximity, particularly if nurse needed the same day;

3. Casual has nominated specific facility;

4. Casual has nominated specific ward, if relevant;

5. Availability dates cross-match;

6. (1a) Casual has prerequisite qualifications required by the facility, e.g. Paediatric ICU qualifications; or
(1b) Casual has preferred qualifications required by the facility, e.g. Paediatric ICU qualifications;

7. Search the nurse ranking categories set out above

8. Within each of the ranking categories, option to give preference to casuals who do not require childcare;

9. With each of the ranking categories, give preference to casuals who require the least number of hours of childcare for the period in question;

10. Highest number of days worked in the specific position/ward within the relevant facility;

11. Highest number of days worked with the relevant facility (Most Often);

12. Worked recently, worked in ‘ward/facility’

13. Additional skills and interests such as the specific principal's/DON's (Director of Nursing) request for a casual who can speak a nominated language>This becomes a separate category which needs to be assessed independently provided the casual has meet the aforementioned ranking category.

All nurses registered with the system 1 have their identification information also stored on the system. The nurses registered with the system have access via their personal computers or laptops 4 or PDA, Phones, or wireless devices, to their own sub-systems with individual calendars/diaries containing approximately two years of dates upon which nurses place and update their availability information for transfer and storage in an availability data store 5. When the nurse accepts or rejects a vacancy, such as an offer of employment the calendars/diaries are updated on the system database 5.

An example of the candidate information that the nurse would be required to supply is as follows:

Name

Phone number:
Home:
Mobile:

E-mail Address:

Address (suburb and postcode only):

Postal Address (for internal health care facility records only, used to post salary cheques, superannuation information and other relevant information.)

Type of nurse (use code):
Specialties qualified to nurse (list codes):
What levels of nursing qualifications:
Nurse's registration number from the Board of Nursing Registration
List of health care providers where prepared to nurse:
Specific health care providers (list code):
Districts:
Locations:

List specific health care providers (if any) where not prepared to work (list code):

Option of including CV/resume

The nurse's sub-system would reflect this information. On a regular basis each nurse would update his/her availability, thus maintaining the calendar/diary's accuracy.

For accounting reasons the system also records the health care facilities at which the nurse was employed through the system and the term of each period of employment. In addition the number of days each nurse was absent each year could also be recorded, if the employer sought this service.

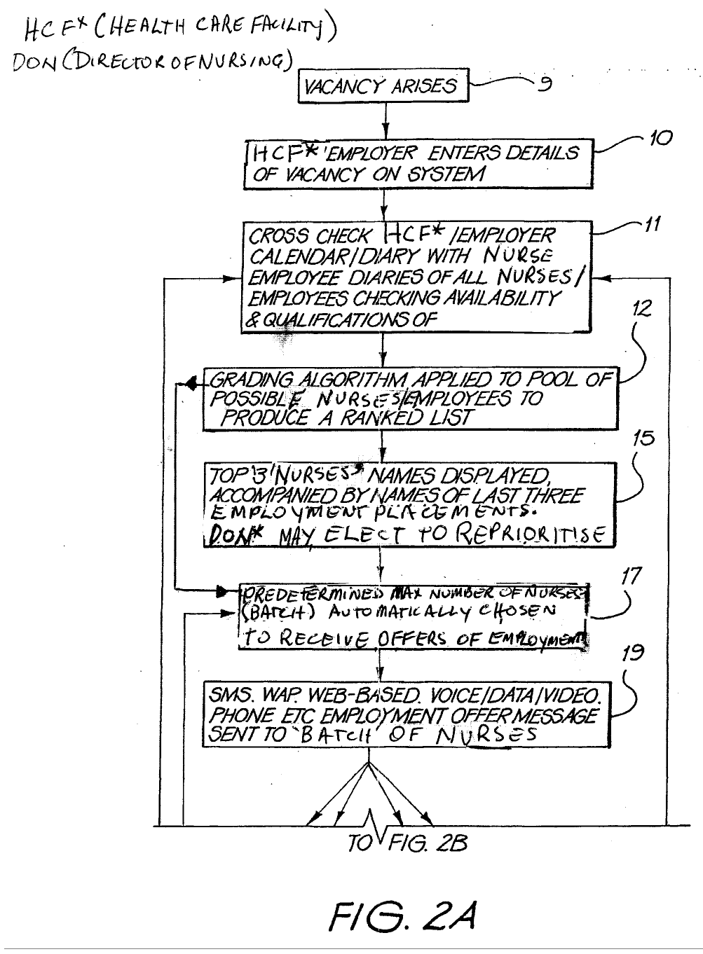

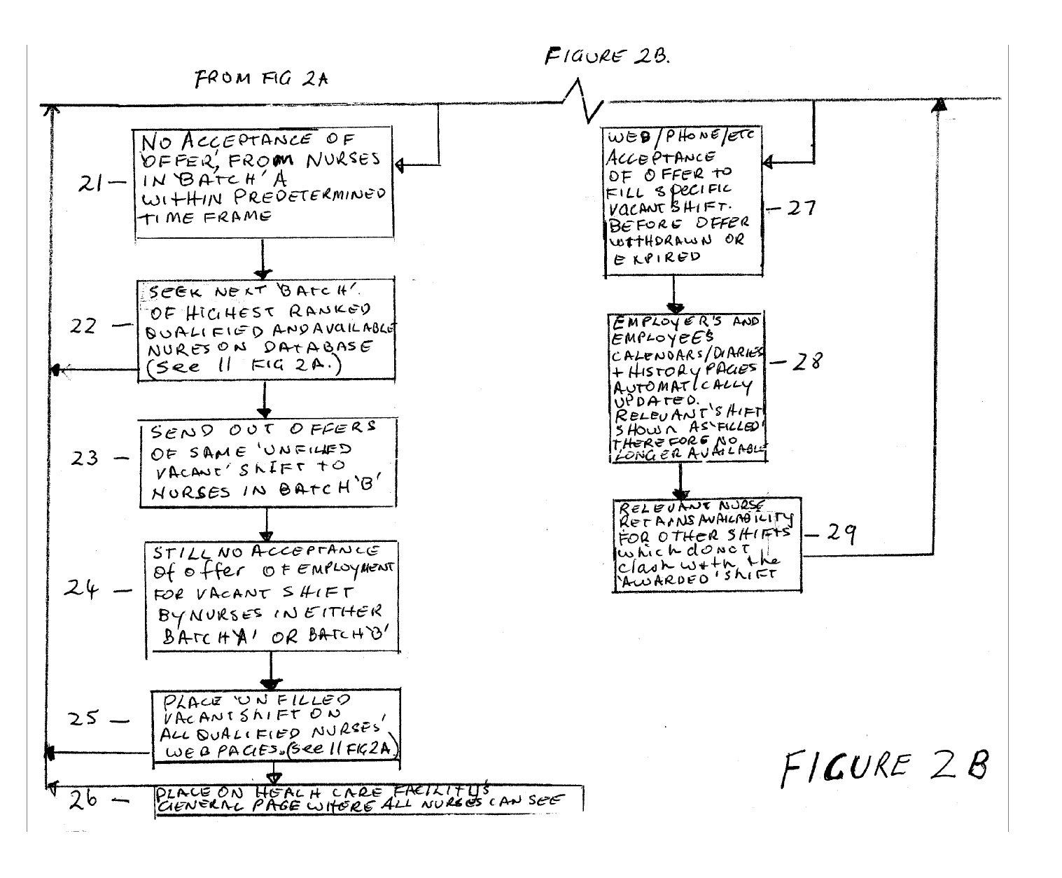

Referring now to FIG. 2, when a vacancy/vacancies arise/s 9, the health care facility uses the software applications installed on the health care facility's sub-system 2 to list the vacancy/vacancies on their calendar/diary 10 and to generate vacancy data. The type of information required would be as follows:

Place of employment (name of health care facility);

Wards in which vacancy occurs;

Type of nurse required (use code);

Starting date of employment;

Number of vacant shifts;

Duration of the shift(s) such as start and end time;

Any special qualifications required (if any);

Location of childcare facility.

This information could be entered into the system directly by the health care facility in the event of a vacancy. Alternatively, if the health care facility's sub-system 2 maintained a record of the nursing commitments of the current staff, the health care facility may select the name of the nurse that is absent and enter the dates which the nurse needs to be replaced. In this way, the system may retrieve automatically from the system the details of that nursing commitment that needs replacing, and accordingly the qualifications that the replacement nurse needs. More than one vacancy could be entered into the system in this manner.

The entering of vacancy information by a health care facility automatically activates the system 1. The system receives the vacancy information and stores it in a vacancy data store, and then performs a cross-check of the vacancy details with the existing nursing commitments of the staff employed by the health care facility to provide the most appropriate and economical manner to replace the nurse, in that the current staff may be able to cover some of the absent nurse's commitments. Also or alternatively, the health care facility's requirements are cross-matched 11 against all nurses registered on the system. Any nurse that is qualified to fill the vacancy, possesses the special qualifications requested (if any) and is available will appear on the list of generated people.

This list is then ranked 12 using the categories predefined by the health care facility listed above including a ‘seek-first-search’ list of particular nurses who are given the overall highest ranking for that health care facility.

If the health care facility has pre-selected a fully automated option they will have previously nominated a maximum number of nurses that can initially receive an offer of employment for the vacancy (that is they receive the vacancy information). The fully automated system will select a ‘batch’ of highest ranked nurses, the number of nurses in the ‘batch’ being equal to the predetermined maximum number of nurses that can initially receive the offer 17. Once the ‘batch’ has been selected, the nurses included within that ‘batch’ will be sent an offer of employment message which is automatically compiled and communicated in real-time 19.

In addition, some health care facilities may prefer for the DON to view a selected number of the most highly ranked available qualified nurses in order to choose which specific nurses will receive offers of employment or to reprioritize the order in which such nurses will receive the relevant offer of employment 15. The names of the a nominated number of nurses at the top of the list along with their qualifications and CV etc can be displayed to the DON 15 who may elect to reprioritize the list. The health care facility has the option to automatically re-sort any random casuals within their particular categories.

If there is no request to accept the offer of employment from nurses in Batch ‘A’ within a predetermined timeframe 21 then the system selects 22 the next batch (Batch ‘B’) of highest ranked nurses from the list 12. The size of this batch is also predetermined by the health care facility. The same offer of employment 19 is then sent to nurses in Batch ‘B’.

After a predetermined timeframe, if there is still no request to accept the offer of employment from either the nurses in Batch ‘A’ or Batch ‘B’ 24 then the offer can be sent to the next batch of highest ranked nurses from the list and this is repeated until an acceptance is received or the offer can be placed 25 on all qualified nurse's sub-systems, such as visible on a webpage that interfaces them into the system. That is all qualified nurses that access the system 1 using their subsystem 4 will be able to view and accept the offer.

After another predetermined period of time, if the offer still remains unfilled it may be placed on the health care facility's general page which may be made available to nurses outside the system 26.

If at any stage a request is received to fill the vacancy 27 before it is withdrawn by the health care facility or expires then the health care facility's and nurse's calendars/diaries and history pages are automatically updated. The request is accepted and the vacancy is considered filled and is therefore no longer available to other nurses 28. The first nurse to request to accept the offer will be the only request to fill the vacancy accepted by the system. The nurse who successfully accepted the relevant offer remains available for other shifts which do not clash with the newly accepted shift 29.

It is important to understand that the relevant offer of employment stays available until actually filled, withdrawn by the health care facility or expires. The relevant health care facility may elect to ensure that the highest ranked nurses get a head start by being notified of the offer as soon as the vacancy is entered. The nurses' head start does not give them exclusivity in relation to the offer.

The system works on a ‘first in: first served’ philosophy even though the system may have only messaged the highest ranked nurses. The advantage is that it enables offers to be accepted in real time and for nurses' availability calendars and the health care facilities' history pages to be updated in real time and therefore to enhance the degree of accuracy of such records.

The system will not enable a health care facility to make an offer to a nurse who is already committed to work a conflicting shift at either the same health care facility or another health care facility.

The use of devices such as a PDA linked via wireless LAN or other mobile devices connected either via LAN, WAN or via a wireless connection to the internet, or via a mobile phone, will enable both DONs and nurses to always be aware of the status of vacancies. In addition, DON or their appointees will be able to immediately update changes to the status of the number of offers and initiate procedures for messaging or advertising or withdrawing such offers without the need to be ‘tied down’ to a desktop or even a laptop computer. Furthermore, nurses may be able to use such devices to immediately accept offers. In each case the nurses will be able to look at their history page in order to see the status of which offers they have accepted as well as browse the advertised vacancies page for additional offers which suit their requirements.

Advertised Vacancies

Advertised vacancy may be used without performing the steps 11 to 24 of the method described above.

The advertised vacancies page enables a large number of nurses to be made aware of and compete for the offers, that is compete to have their request to fill the vacancy accepted. Referring back to step 26, the advertised vacancies page would be available to advertise any unaccepted offers. A nurse could request to accept any one or more of the offers advertised on the page if the nurse meets all of the prerequisite qualifications. Once the nurse submits a request to accept the system could cross-check that the nurse meets the health care facility's ranking requirements (eg not ranked below ‘If Required’ as well as any distance/travel limits as indicated by postcode restrictions that may be imposed by the relevant health care facility). In this example, the offers are viewable by all nurses registered with the system.

Alternatively, an offer on the advertised vacancies page may only be viewable by a nurse if that the nurse's calendar indicates that they are available and that they have the requisite qualifications in order to successfully request to accept the offer. Further, the offer may only be viewable by the nurse provided that they have also indicated that they may accept offers of employment from the health care provider and/or ward that the offer relates to. Thus before an offer in placed on a nurse's advertised vacancies page the system would check the nurse's availability, qualifications, and ranking in order to ensure that only those offers which the nurse can actually accept without additional checking by the system's database are displayed to the nurse. In this way, each nurse's advertised vacancies page is individualised.

In the case of individualised advertised vacancy pages the health care facility can also elect to use various optional filters in order to better control which nurses see which of the offers. The health care facility may decide that:

1. All nurses registered on the system can view all of the offers placed on the advertised vacancies page;

2. Nurses meet the relevant health care facility's prerequisites can view the offer

3. Only the nurses whose availability according to their calendars means they are free to accept the offer;

4. Even if the nurse is not available according to their calendar, if they have indicated that they are prepared to fill vacancies from that health care facility the offer should be made visible to them

If a health care facility elects to stagger which nurses can view the offer on the advertised vacancies page according to the ranking 12, even when the offer is viewable by lower ranked nurses any nurse, even a nurse from the higher rank, may accept the offer.

Once a nurse accepts an offer on the advertised vacancies page the system will automatically accept the nurse's acceptance. Automatically the nurse's availability calendar and the nurse's history page will be updated 28. The health care facility's history page will also be updated 28 and the offer will automatically be removed from the advertised vacancies page.

In one embodiment, a message such as an SMS or an e-mail can be sent to a nurse informing them that a new offer is now available on their individualised advertised vacancies page.

To give the health care facility more control the acceptance of offers on advertised vacancies pages could be less automated to allow the health care facility to review a request to accept an offer (that is, fill a vacancy) before allowing it to be accepted by the system and processed 28. To achieve this the telephone number of the Director of Nursing could appear once a nurse has selected the offers that he/she wishes to request to accept from the advertised vacancies page. The nurse could then phone the number and arrange to work those shifts over the phone. On receipt of the phone call the Director of Nursing could input the nurse's name and identity code into the system using their sub-system 2. The nurse's qualifications and history would appear on the screen. If the Director of Nursing is satisfied with the nurse's history etc, the Director of Nursing could open the health care facility's system calendar input that the nurse has accepted the offer over the phone. The Director and nurse may also discuss other offers at this time that may not already be on the advertised vacancies page. Step 28 then follows.

In another example of a less automation, the nurse may request to accept an offer and a message could then be automatically sent to health care facility with details of the request to accept, such as a filled in e-mail template. The nurse's acceptance would then appear on the health care facility's sub-system. By clicking on the relevant shift, the names and contact numbers of the nurses who had indicated that they were willing to work the relevant shifts would appear. The health care facility could either then phone or message the nurse.

Alternatively, the health care facility may opt to use both the automated acceptance of offers and the phone contact requirement. In this way the relevant health care facility can check overtime considerations. There may also be other considerations that the relevant health care facility may opt to take into account.

In a further embodiment of the invention, the health care facility may choose to skip steps 11 to 24 and simply go to step 26. In this case the advertised vacancies page would be function in any of the ways described above.

Time Sensitive Payment Rates

Each health care facility could elect to preset an automated time sensitive payment system. For example, if there is more than two weeks before a vacancy starts the health care facility may elect not to offer more than the award rate. Between two weeks (336 hours) and one week (168 hours) the health care facility may elect to offer an additional fee eg +$10 for each of offer accepted. Between one week (168 hours) and three days (72 hours) the health care facility may elect to offer +$20 for each offer accepted. For less than 3 days (72 hours) the health care facility may realise that the only alternative would normally be to pay a nursing agency the excessive rates charged by most nursing agencies and offer to pay a rate of say an additional $30.

Alternatively the health care facility could advertise a dollar amount for the relevant shift. Another alternative would be for the health care provider to advertise the specific hourly rate for an offer. Higher qualified or ranked candidates could be offered a higher price/wage.

As the system becomes more widely used the supply of nurses should increase and the interaction between supply and demand should enable the health care facilities to influence the price downwards. The more widely used the system is by both nurses and health care facilities the more the health care facilities can aggregate their market power to control the price of labour and the more they can reduce their reliance on nursing agencies for the supply of nurses.

Possible Overtime Payments

A nurse that is either from the specific health care facility's permanent full-time or part-time permanent staff is “tagged” for that specific health care facility. If a tagged nurse accepts an offer on the advertised vacancies page the health care facility can then check to see if the nurse will go into overtime if the offer is accepted by the nurse. In NSW Australia, permanent nurses generally qualify for overtime rates of pay if the nurse works in excess of the rostered daily ordinary hours of a permanent full-time nurse eg more than an eight-hour shift or if the permanent nurse works more than 76 hours in a rostered fortnight.

Also, each health care facility can search for a specific nurse and know her availability as well as the number of shifts the nurse is already working in the health care facility in order to avoid overtime commitments.

The health care facility would need to enter the nurse's name and registration number. The system will then show the nurse's details on the screen and the shifts that the nurse is already committed to work in the relevant health care facility. The system would also show what shifts the nurse is available to work in the relevant health care facility.

Depending on privacy considerations, the system could indicate that the nurse is already booked for a shift but would not show the name of the facility that the nurse is working at, if it was not the same health care facility that was actually conducting the search.

Agents' Page

The health care facility may opt to offer the nursing agencies the same amount of money the health care facility is offering nurses plus a preset additional amount for the agencies, e.g. $30 per shift filled.

The amount offered to both nurses and agencies is preset by each health care facility. The amount paid by the health care facility can be a standard amount or can be time-sensitive in that the amount paid by the health care facility may increase as the number of days remaining before the actual shift of the offer is due to start is reduced.

The nursing agencies would be allowed to register with the system and view a page accessible by agents only. A nursing agency could submit requests to accept offers on behalf of nurses that they have on their nursing agency books. If this is the first occasion that the nurse is using the system to accept an offer the nurse may still have to register so that the system can ensure that she is not nominated by several agencies for the same time or that the nurse had not accepted another offer for the same time. The agency may be encouraged to submit the relevant nurse's whole name and State Nursing Registration Board registration number so that the system could check that the nurse was not already booked somewhere within the system.

The system would treat the agency like a nurse. So if a nurse that requested to accept an offer through the agency and did not turn up (no shows), this would be marked negatively against the agency. In effect the ‘no shows’ would count against both the nursing agency that provided the nurse as well as the nurse.

To assist security the nursing agency page would be separate from the nurses' advertised vacancies page. This would allow a different pricing system to be displayed to the agencies.

One aim is to get agencies to compete for the relevant vacancies on an open market. The relevant health care facility can adjust prices according to success rate and thus open the market to supply and demand forces. In effect this should aggregate the combined powers of the health care facilities and providers. Agencies would be aware of all of the vacancies in their relevant geographical area the agencies would have to compete against other agencies and nurses to accept the offer.

Agency Auction Page

In addition to, or as an alternative to the agency page there could be an agency auction page. In this section, the health care facilities could nominate a reserve price for an offer eg +$30. If a nursing agency decided to accept the offer at the reserve price which has been pre-set by the health care facility then the nursing agency accepts the offer on behalf of a nurse.

If the nursing agency is not prepared to provide a nurse at the reserve price of +$30 the agency may nominate (bid) its agency preferred price eg +$60. This agency preferred price would be communicated to the health care facility via the system and would appear as an agency bid of +$60 for the offer. During this period the offer remains displayed on the nurses' advertised vacancies page, the Agent's page and the agency auction page. If another agency meets the reserve price then the offer will be accepted, the offer removed from the system and processed 28.

While the relevant health care facility may have initially nominated the reserve price as +$30 it could employ a time sensitive increasing reserve. That is to say that the reserve may increase as the time remaining before the relevant shift decreases. Thus as previously explained two weeks or more out the health care facility may elect not to offer more than the nominated +$30 for the relevant shift. Between two weeks and one week the health care facility may elect to offer an additional fee eg +$10 making the reserve +$40. Between one week and three days the health care facility may elect to offer an additional fee of +$20 for those relevant shifts making the reserve price +$50. For less than 3 days the health care facility may realise that the only alternative would normally be to pay a nursing agency the normally excessive nursing agency rates and thus the health care facility may elect to use this service to pay a rate of say an additional $30 making the reserve price +$60.

In effect, the +$60 bid by the aforementioned agency would be initially ignored/rejected if made two weeks prior to the start of the shift of the offer. However, because of the moving reserve the +$60 bid would meet the reserve if it was still available when there was only 3 days left before the relevant shift.

The system sends an email/message to the relevant agency informing the agency that the offer is now within the reserve price and that the agency could request to accept by providing the details of the nurse. The offer would remain advertised until the system had checked the request to accept to ensure that the nurse met all the relevant criteria.

Nurse Auction Page

Nurses may also have the option of placing bids for an offer just as described above in relation to agencies. In this case the nurses would be bidding against each other. A nurse may bid above the relevant ‘reserve’ set by the health care facility. The health care facility could accept the nurse's bid once the reserve had risen sufficiently to match the nurse's bid.

Nurses with Childcare Requirements

Each shift on the advertised vacancies page could also indicate whether there was childcare available for the duration shift of an offer. This could simply be a colour code or an extra column. The nurse could click on the symbol to get details of how many child care placements were available and the cost.

Checking the Accuracy

The system may provide a checking mechanism to ensure that nurses have updated their availability calendars within a set period eg last 14 days, or have at least visited their webpage. This would be done in order to ensure that the nurse's availability calendar reflects his/her actual availability, and to ensure that the nurse's page is not ‘dormant’ or that the nurse has abandoned the system and yet has a calendar showing availability to accept shifts.

Similarly, a checking mechanism would be used to ensure that health care facilities update the accuracy of offers that they have advertised on the advertised vacancies page. This should monitor that a health care facility removed a specific offer if circumstances have changed.

The checking mechanism could take various forms. The system identifies and logs each time a health care facility or a nurse logs into their relevant webpage and also logs the nature and date of any changes. If there have not been any recent log-ins or changes a message can be sent to the relevant party asking them to confirm the information displayed on their relevant pages, or just send them a reminder to frequently update their information in order to maintain the accuracy/currency of such information.

The system would include an accuracy status function which would record the number of times a health care facility or a nurse failed to maintain their relevant pages so that the information displayed on the pages was accurate. Once the relevant accuracy status reaches a predetermined value the relevant health care facility or nurse is sent a warning/reminder. Future indiscretions would result in suspension of the health care facility or nurse from the system for a period. The value of the accuracy status could be used to prioritise a nurse's ranking in future lists of available nurses generated by health care facilities. Similarly, health care facilities may have a percentage value displayed next to their names indicating the probable accuracy of offers.

The accuracy status is a way of exerting pressure on the health care facilities to ensure the accuracy of the offers advertised on their advertised vacancies pages and exerting pressure on each nurse to ensure that he/she maintains an up-to-date calendar which genuinely reflects his/her willingness to accept offers. Thus the accuracy status should reduce the capacity for spurious hits by nurses on offers which are not genuinely available. The accuracy status should also reduce the incidence of offers being displayed on the advertised vacancy pages of nurses who are not available but who indicate that they are available according to their calendars. Furthermore, by exerting pressure on the nurses to maintain the accuracy of their availability calendars the size of the pool of available nurses to whom an offer is advertised is increased. This is particularly relevant if the relevant offer is only advertised on the pages of those nurses who indicate via the parameters set by their availability calendars that they available to accept the offer.

The system would track the record of each nurse's ‘no shows’. The system would quickly ‘isolate’ the ‘unreliable’ nurses who would be suspended or permanently removed from the system.

Similarly, the system would track the record of health care facilities which continued to advertise offers which were no longer available.

Probability of Success

The system may also include a mechanism whereby a health care facility can, having entered the details of offers they wish to advertise, see how many nurses registered on the system match the criteria set by the health care facility. In this way the health care facility would receive an indication of the probability of success of the advertisement and/or an indication of the optimum size of any batches (eg. the number of nurses to include in the initial batch etc) that the health care facility may decide to use. Additionally, the health care facility could get a list of the actual names, qualifications and contact details of the actual nurses who are available for the offers and who meet the health care facility's criteria. However, if a health care facility elects to not use availability as a filtering criteria then projected figures of nurses who would be likely to work the shift would not be as accurate.

Additional Information which Could be Communicated by the System

The system could be used to display whether a health care facility offered ‘Salary Packaging’ to casual nurses and employees etc and to what level or degree the salary packaging.

Each offer that is accepted using the system will indicate the origin of the acceptance. That is, was the nurse acceptance processed automatically by the system or whether the acceptance also involved personalised communication by way the phone. If a problem arises with an acceptance, the details of the nurse's placement can be traced in order to keep a statistical record of the efficacy of each method and of the capacity of people using the system

Advertising Permanent Jobs

As the health care facilities become acquainted with using this system on a regular basis it would provide an opportunity to include an advertised permanent positions page, in which the health care facilities could list their various vacancies for permanent or contract staff along with pictures of the health care facility, descriptions of recent improvements or events within the health care facility and descriptions of the facility and the position. Interested prospective employees could then send in their resumes and/or details by email and messaging etc or make relevant phone enquiries.

While this system has been described with particular reference to the employment of nurses within the health care system, it should be appreciated that the system could be altered to recruit any form of staff within any area of employment.

Other employers that may utilise the system are government and semi-government bodies, banks, retailers, service providers, casinos and professional bodies may enter into a contract in which the service is provided directly to them. This could be seen as an in-house service or an out-sourcing service and would be negotiated on an employer by employer basis. Such a scheme would highlight the individual employer's level of control over the process, whilst at the same time enabling the employer to quickly obtain staff without the current excessive fees associated with outside bodies such as nursing or employment agencies.

On the other hand the service could take the form of a more general format in which the system seeks to enlist as many casuals, part-time and contract workers as possible and then basing the revenue on either charging them a membership fee, placing them on phone contracts, or charging the employer and/or employee a placement fee or percentage of wage/salary fee. Obviously such an approach would still require the cooperation of large-scale employers. However, it would differ from the previous approach in as much as the employer is not contracted for the provision of service specifically designed for their company and over which that company has a larger degree of control.

In addition the time sensitive reserve can be used as described as above in relation to employment or services where the reserve price/cost of employing someone rises as the time before the first shifts that is required to be worked gets closer to the time that the nurse or casual employer or contractor ‘Offers’ to work the relevant shift(s). This could be seen as a ‘reverse or negative relationship’. Obviously the time sensitive reserve can be used in a ‘positive relationship’ in which the price of the ‘item’ or service to be purchased or acquired decreases as the time remaining before the event decreases eg. as the time remaining before the start of a ‘show’ decreases so does the price of the show or holiday accommodation etc, as the managers, owners or promoters of the item use the automated time sensitive reserve or ‘moving reserve’ to decrease the ‘price’ of the relevant item in line with the declining window of opportunity to ‘shift/sell’ the relevant item or service.

The system can be expanded to add favourable features in the future directed towards the specific industries that are the end users of the system. This could include a chat room to attract users to this service and provide a forum where appropriate issues could be discussed and a more expansive calendar including social, seminar and conference dates. Systems contracted to specific large employer, employer groups/bodies or even union groups could include industry related news on upcoming seminars, conferences, notices for upcoming permanent employment positions and relevant advertising. The system could also be adapted to include information about job and/or house renting/swapping or the provision of accommodation in appropriate holiday periods or the provision of other services. Specifically targeted advertisements of interest to the users could be included and would also serve as a generator of income. Professional advice such as resume updating and career management could also be introduced to the system in order to encourage people to use the system.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

What is claimed is:

1. A method for filling vacancy periods having a defined start and end comprising the steps of:
receiving vacancy data and storing it in a vacancy data store;
receiving candidate data and storing it in a candidate data store;
receiving a request from a candidate to view the vacancy data using a website;
automatically sending vacancy information to the candidate to be viewed on the website;
receiving a request from the candidate to fill the vacancy; and
accepting the request to fill the vacancy.

2. A method for filling vacancy periods according to claim 1, wherein the vacancy data includes criteria that the candidate must meet in order to fill the vacancy and the candidate data comprises information on criteria that is needed to fill the vacancy, wherein the step of sending vacancy data to the candidate comprises cross-matching the vacancy criteria with the criteria information of the candidate and only sending the vacancy data if the candidate meets the criteria.

3. A method for filling vacancy periods according to claim 1 or 2, wherein the candidate data comprises availability information of the candidate, wherein the step of sending vacancy data to the candidate comprises cross-matching the vacancy period with the availability information of the candidate and only sending the vacancy data if the candidate is available to fill the vacancy.

4. A method for filling vacancy periods according to claim 1, 2 or 3, wherein the step of accepting the request to fill the vacancy is automatic.

5. A method for filling vacancy periods according to claim 1, 2 or 3, wherein the method further comprises the candidate contacting the employer or the employer contacting the candidate to first discuss the vacancy.

6. A method for filling vacancy periods according to any one of the preceding claims, wherein candidates are ranked according to a predetermined criteria, and the step of sending vacancy data to the candidate is performed provided the candidate is of at least a predetermined ranking.

7. A method for filling vacancy periods according to claim 6, wherein the predetermined ranking changes as the amount of time until the defined start of the vacancy reduces.

8. A method for filling vacancy periods according to claim 6 or 7, wherein the predetermined criteria and predetermined ranking is predetermined by the employer.

9. A method for filling vacancy periods according to any of the preceding claims, wherein the vacancy data includes a monetary amount offered to the candidate who fills the vacancy.

10. A method for filling vacancy periods according to claim 9, wherein the monetary amount offered increases as the amount of time until the defined start of the vacancy reduces.

11. A method for filling vacancy periods according to claim 9 or 10, wherein the monetary amount is dependant on the skills of the candidate.

12. A method for filling vacancy periods according to claim 9, 10 or 11, wherein the request from the candidate includes an alternate monetary amount that the candidate would be prepared to fill the vacancy for.

13. A method for filing vacancy periods according to any one of the preceding claims, wherein the candidate is a person or an agency acting on behalf of a person.

14. A method for filling vacancy periods according to any one of the preceding claims, wherein the vacancy data includes information on whether child care is also available for the vacancy period.

15. A method for filling vacancy periods according to any one of the preceding claims, wherein the receiving and sending steps are performed using the Internet as a communication medium.

16. A method for filling vacancy periods according to any one of the preceding claims, wherein the request from the candidate to view the vacancy data comprises the candidate logging into the website.

17. A computer system for filling vacancy periods having a defined start and end, comprising:
a candidate data store to accept and store candidate data;
a vacancy data store to accept and store vacancy data;
a processor connected to the Internet and operates to receive a request from a candidate to view the vacancy data using a website, to automatically send vacancy data to the candidate to be viewed on the website and to receive a request from the candidate to fill the vacancy, wherein the request to fill the vacancy is accepted.

18. A computer system for filling vacancy periods according to claim 17, wherein the vacancy data includes criteria that the candidate must meet in order to fill the vacancy and the candidate data includes information on criteria that is needed to fill the vacancy, and the processor operates to cross-match the vacancy criteria with the criteria information of the candidate and only sends the vacancy data if the candidate meets the criteria.

19. A computer system for filling vacancy periods according to claim 17 or 18, wherein the candidate data comprises availability information of the candidate, and the processor operates to cross-match the vacancy period with the availability information of the candidate and only sends the vacancy data if the candidate is available to fill the vacancy.

20. A computer system for filling vacancy periods according to claim 17, 18 or 19, wherein the acceptance of the request to fill the vacancy is automatic.

21. A computer system for filling vacancy periods according to claim 17, 18 or 19, wherein the candidate contacts the employer or the employer contacts the candidate to first discuss the vacancy before the request to fill the vacancy is accepted.

22. A computer system for filling vacancy periods according to any one of claims 17 to 21, wherein the processor operates to rank candidates according to a predetermined criteria and only sends vacancy data to the candidate provided the candidate is of at least a predetermined ranking.

23. A computer system for filling vacancy periods according to claim 22, wherein the predetermined ranking changes as the amount of time until the defined start of the vacancy reduces.

24. A computer system for filling vacancy periods according to claim 22 or 23, wherein the predetermined criteria and predetermined ranking is predetermined by the employer.

25. A computer system for filling vacancy periods according to any of claims 17 to 24, wherein the vacancy data includes a monetary amount offered to the candidate who fills the vacancy.

26. A computer system for filling vacancy periods according to claim 25, wherein the monetary amount offered increases as the amount of time until the defined start of the vacancy reduces.

27. A computer system for filling vacancy periods according to claim 25 or 26, wherein the monetary amount is dependant on the skills of the candidate.

28. A computer system for filling vacancy periods according to claim 25, 26 or 27, wherein the request from the candidate includes an alternate monetary amount that the candidate would be prepared to fill the vacancy for.

29. A computer system for filing vacancy periods according to any one of claims 17 to 28, wherein the candidate is a person or an agency acting on behalf of a person.

30. A computer system for filling vacancy periods according to any one of claims 17 to 29, wherein the vacancy data includes information on whether child care is also available for the vacancy period.

31. A computer system for filling vacancy periods according to any one of claims 17 to 30, wherein the processor receives requests and sends vacancy data using the Internet as a communication medium.

32. A computer system for filling vacancy periods according to any one of claims 17 to 31, wherein the request from the candidate to view the vacancy data comprises the candidate logging onto the website.

33. A method for filling vacancy periods having a defined start and end comprising the steps of:
entering candidate data into a candidate data store;
entering vacancy data into a vacancy data store;
creating a list of candidates for a vacancy and automatically ordering the list using a computer to rank the candidates according to predetermined criteria;
communicating the vacancy data to a first predetermined number of top ranked candidates; and
if a positive response to fill the vacancy is not received within a predetermined time, communicating the vacancy data to a second predetermined number of top ranked candidates that are next top ranked;
repeating the above step until the positive response to fill the vacancy has been received.

34. A method for filling vacancy periods having a defined start and end according to claim 33, wherein the step of communicating the vacancy data comprises making the vacancy data available on a webpage.

35. A method of for filling vacancy period according to any one of claims 1 to 16, and 33 or 34 and substantially herein described with reference to the accompanying drawings.

36. A computer system for filling vacancy periods according to any one of claims 17 to 32 and substantially herein described with reference to the accompanying drawings.
